(19) United States
(12) Patent Application Publication
(10) Pub. No.: US 2013/0325847 A1
(43) Pub. Date: Dec. 5, 2013

(54) GRAPH-BASED SEARCHING

(71) Applicants: Sean Andrew Suchter, Los Altos Hills, CA (US); Charles Converse Carson, JR., Cupertino, CA (US); Rajesh Krishna Shenoy, San Jose, CA (US)

(72) Inventors: Sean Andrew Suchter, Los Altos Hills, CA (US); Charles Converse Carson, JR., Cupertino, CA (US); Rajesh Krishna Shenoy, San Jose, CA (US)

(73) Assignee: MICROSOFT CORPORATION, Redmond, WA (US)

(21) Appl. No.: 13/487,565

(22) Filed: Jun. 4, 2012

(51) Int. Cl. G06F 17/30

(52) U.S. Cl. 707/722; 707/E17.082

(57) ABSTRACT

Improved, personalized searching through the use of personal connection graphs is presented. Responsive to receiving a search query, the search engine obtains a user sketch (representing a user's connection graph) and obtains search results responsive to the search query and also based, in part, as a function of a relationship distance between the user and the referenced content as determined by the user sketch. One or more search results pages are generated from the obtained search results and returned to the user.

### BACKGROUND

Search engines increasingly provide personalized search results in response to users' search queries. Search engines personalize search results for a given user by taking into account a user's current context (location, type of device, time of day, etc.), the user's preferences—both implicit and explicit, prior searching and browsing behaviors, the preferences of the user's social network, and the like. However, the process to personalize search results comprises the discrete steps of receiving a search query, obtaining a set of search results corresponding to the query, and then personalizing the search results to the user. In other words, search engines separate the process of results retrieval from results personalization.

### SUMMARY

The following presents a simplified summary in order to provide a basic understanding of various embodiments described herein. This summary is not an extensive overview, and it is not intended to identify key and/or critical elements or to delineate the scope thereof. The sole purpose of this summary is to present some concepts in a simplified form as a prelude to the more detailed description that follows.

In one embodiment of the disclosed subject matter, an improved method for responding to a search query is presented. Responsive to a search query, a user sketch representing a connection graph of the user is obtained. According to various embodiments, the user sketch may be obtained from a data store storing a plurality of user sketches or may be generated in response to the search query. Search results are then obtained according to the search query and, in part, according to a function based on a relationship distance between content and the user in accordance with the user sketch. At least one search results page is generated, including any results obtained as a relationship distance according to the user sketch, and returned to the user in response to the search query.

In an alternative embodiment of the disclosed subject matter, a computer system for responding to a search query from a user is presented. In this alternative embodiment, the computer system comprises a processor for executing instructions from a memory, and further comprises additional logical and/or physical components. These include, but are not limited to: a content index (i.e., an index of references to content); a user sketch component that obtains a user sketch corresponding to a user submitting a search query; a retrieval component that retrieves search results responsive to the user's search query and, in part, as a function of a relationship distance between content in the content index and the user according to the user sketch; an access management component that determines whether the user has access to the search results retrieved, at least in part, as a function of the relationship distance between the content and the user, removing those search results to which user does not have access; and a search results page generator that generates one or more search results pages based on the retrieved search results and returns the search results pages to the user in response to the search query.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a diagram of an exemplary networking environment suitable for implementing graph-based searching;

FIG. 2 is a diagram illustrating an example of a user's social graph, a Web graph, and the interrelationships between the two;

FIG. 3 is a diagram illustrating the user's social graph of FIG. 2 reduced into a set of sketches and combined into the Web graph;

FIG. 4 illustrates an exemplary routine for responding to a user's search query using graph-based searching techniques;

FIGS. 5A and 5B are pictorial diagrams illustrating exemplary search results with distance information indicative of graph-based searching; and

FIG. 6 illustrates exemplary components of a search engine suitably configured to implement graph-based searching techniques.

### DETAILED DESCRIPTION

For purposes of clarity, the use of the term “exemplary” throughout this document should be interpreted as serving as an illustration or example of something, and it should not be interpreted as an ideal and/or a leading illustration of that thing.

As used herein, “hyperlink” (also referred to as a “link”) is a reference to data/content at a target site. In some instances, when displayed on a Web browser on a user computer, a hyperlink is user actionable such that, upon activating (e.g., selecting) the hyperlink, the referenced content replaces the current content in the browser. Generally speaking, search results (the information returned from a search engine in response to a search query), are hyperlinks referencing corresponding content at a target sites. Search results in the search results pages are often presented as user-actionable links, commonly displayed in blue to indicate to the user the ability to select (or activate) the link, enabling the user to the referenced content at a target site. As a search results page will often be constructed to include 10 search results and also due to the blue coloration of the search results, these search results are often referred to as the “10 blue links.”

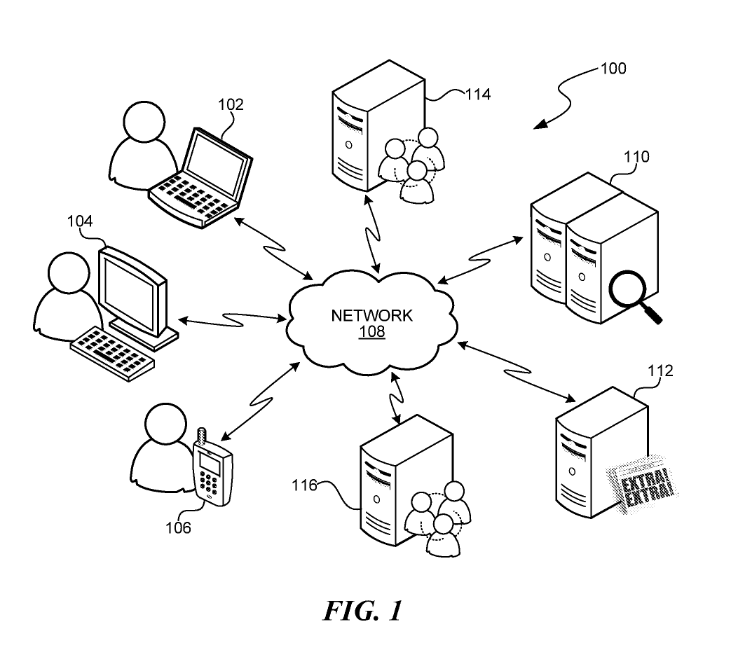

Turning to FIG. 1, this figure shows an illustrative environment 100 suitable for implementing graph-based searching. The illustrative environment 100 includes one or more user computers, such as user computers 102-106, connected to a network 108, such as the Internet, a wide area network or WAN, and the like. Also connected to the network 108 is a search engine 110. Those skilled in the art will appreciate that the search engine 110 corresponds to an online searching service hosted by one or more computers or computing systems distributed throughout the network 108. As shown in FIG. 1, the search engine 110 comprises two computing devices. However, this should be viewed as illustrative only and not limiting upon the disclosed subject matter. As those skilled in the art will appreciate, the search engine 110 receives and responds to search queries over the network 108 from various users, such as the users connected to user computers 102-106. In response to receiving a search query, the search engine 110 identifies relevant content available from various target sites on the network 108. According to the disclosed subject matter, the search engine 110 identifies relevant content according to query terms in the search query and, in part, as a function of a relationship distance between the user and content referenced in the content index. After identifying relevant content responsive to the user query, the search engine 110 generates one or more search results pages and returns at least one search results page to the user.

The illustrative environment further includes social networking sites 114 and 116, as well as content host 112. Those skilled in the art will appreciate that social networking sites, such as social networking sites 114 and 116, enable a user to connect to others (including friends, peers, family members, organizations, and the like) for keeping up-to-date in sharing information. These social networking sites include, by way of non-limiting examples, Facebook, Google+, MySpace, Twitter, and the like. As will be discussed in greater detail below, a user's social network can be viewed as a connection graph between users. Content host 112 is a networked site that hosts one or more items of content (such as web articles, documents, books, scientific articles, patents, and the like), references to content, and/or a database of content and references. In the same manner as social networks can be represented as connection graphs, so too the content of the content host can be represented as a connection graph.

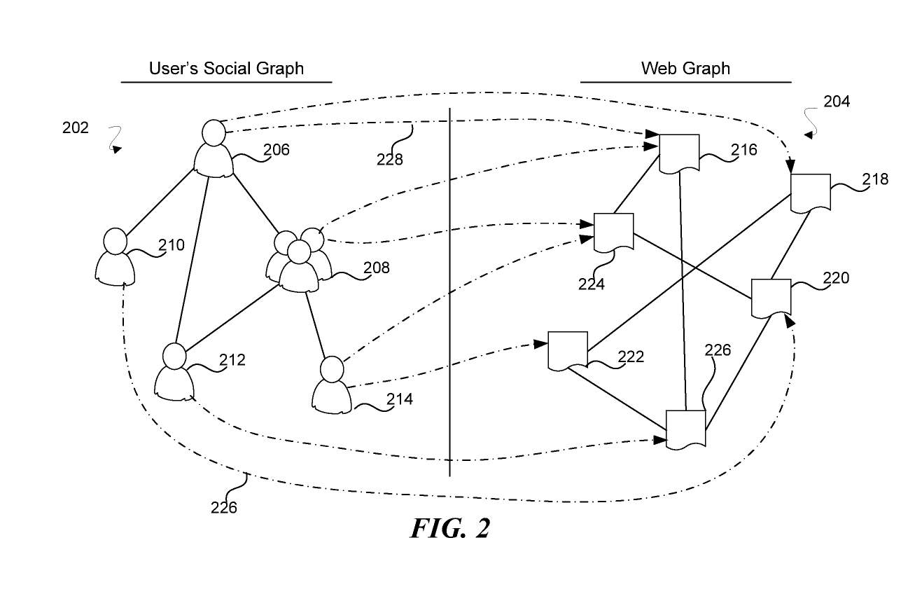

Turning now to FIG. 2, this diagram illustrates a user's social graph 202, a Web graph 204, and the interrelationships between the two. In regard to the social graph 202, for illustration purposes it is assumed that this social graph is the social graph for user 206. As can be seen, this social graph 202 includes the user 206 with connections to user 210 and 212, as well as social group 208. These connections represent relationships of some kind between the users or between users and the social group. In terms of “distance” in a graph, a direct relationship between two users or between a user and a social group is a distance of 1. User 214 has a relationship with the social group 208 but does not have a direct relationship with user 206. In this example, as user 206 has a direct relationship with social group 208, and as user 214 has a direct relationship with social group 208, the distance between user 206 and user 214 on this social graph is 2. In this social graph 202, the distance between user 210 and user 214 is 3 (the distance being the shortest distance between two users/nodes in the graph.)

Also shown in FIG. 2 is a Web graph 204. In this example the “nodes” 216-226 of the Web graph 204 are documents, images, music, video, new articles, or other forms of content, and the connections between the various documents represent a relationship of some kind. By way of example, the content of the Web graph may represent issued patents and the relationships between the patents may be citations. Alternatively, the content of Web graph 204 may be scholarly research and the relationships between documents correspond to authorship (for example, document 216 and document 224 share at least one common author). As with the user graph 202, distances between two nodes (documents) in a graph is determined by the shortest relationship path. Thus, the distance between document 216 and document 218 is 3.

While the relationships between users and user groups in a social graph, such as social graph 202, will often be explicitly established by the individual users, the relationships between content/documents in a Web graph will frequently be determined according to analysis. This analysis may be based on any number of criteria including, but not limited to, the subject matter, authorship, citations, metadata associated with documents, frequency of viewing/browsing/use, and the like. This analysis is often performed by search engines when generating a content index. In any event, a search engine may include a Web graph, in some form, within or as part of the search engine's content index.

FIG. 2 also demonstrates an exemplary inter-graph relationship between the social graph 202 and the Web graph 204. In this example, the dashed lines between users in the social graph 202 and content in the Web graph 204 demonstrate these inter-graph relationships. For example, the dashed line 228 between user 206 and document 216 could indicate that user 206 has viewed document 218. Similarly, the dashed line 226 between user 210 and document 220 indicates a “relationship” between user 210 and document 220. These “relationships” between the two graphs may be based on any number of criteria, including but not limited to: previously viewing a document, authorship, implicit or explicit preference of the content or content source, and the like.

With multi-dimensional graph-based searching, a search engine, such as search engine 110, is able to provide produce a more robust set of search results in response to a search query. In at least one embodiment, a search engine would be able to incorporate information regarding the distance of entities in a first graph (e.g., a social graph 202) in locating search results from a second graph (e.g., Web graph 204). By way of example, assume that the Web graph 204 represents content typically available to a search engine 110 via the search engine's content index, and that the search engine further has access to the users in the social graph 202. With this information, a search engine could respond to a search query with content relating to query term t and where the content is also related to user u from the social graph 202. The search engine 110 could further respond to search queries that included “distance” information as part of the search query, i.e., content in the Web graph 204 related to query term t and related to users within a distance of d of user u. In regard to this latter query, and assuming that user u is user 206 and that the documents in Web graph 204 all relate to query term t, and that distance d is 1, then the results for content related to query term t within a distance d of 1 of user 206 comprises the set of documents {216, 218, 220, 224, and 226}.

As indicated above, in order to conduct this form of multi-dimensional graph-based searching, the search engine 110 must have access to both the Web graph 204 as well as the social graph 202. As mentioned above, the content index (or indices) of a typical search engine 110 will generally include a form of the Web graph 204. To enable multi-dimensional graph-based searching, in at least one embodiment the search engine 110 maintains or stores representation of the social graph 202 as well as the inter-graph relationships between the social graph and the Web graph 204. According to at least one embodiment of the disclosed subject matter, this information (i.e., representation of the social graph 202 and the inter-graph relationships) is stored with the content references in the content index as a “sketch.” In the case of a user's social graph 202, the information is stored a “user sketch.”

For purposes of this disclosure, a “sketch” is a digital representation of at least a portion of a graph. A sketch includes information regarding the represented graph's nodes and the connections between those nodes. Correspondingly, a “user sketch” is digital representation of a user's social network. Typically, the nodes of a user sketch are individual users and/or social groups. Moreover, in at least one embodiment of the disclosed subject matter, to represent an inter-graph relationship between a specific user in the social graph 202 and a specific document within the Web graph 204, the user's sketch is stored with the reference to the content in the search engine's content index. Alternatively, a reference to the user's sketch or an identifier corresponding to the user's sketch may be stored with the reference to the specific content (document).

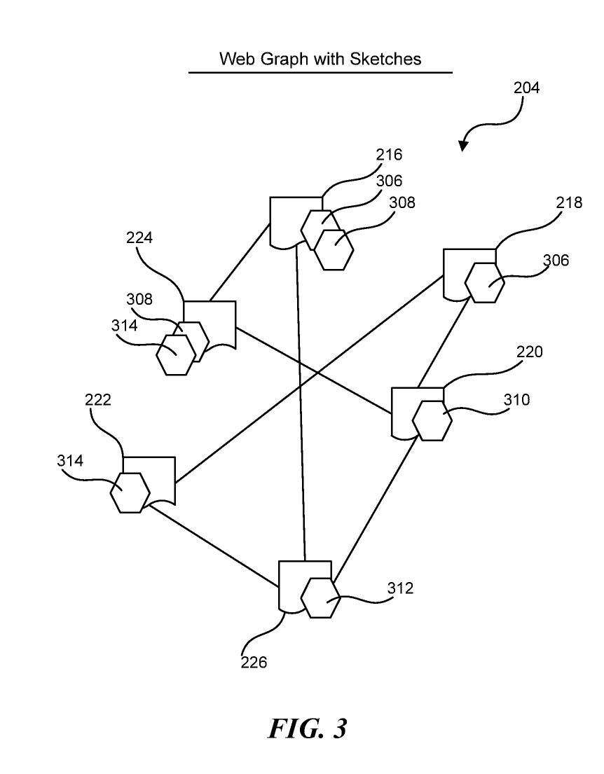

In regard to combining the social graph 202 and inter-graph relationships between users and content into the Web graph 204, FIG. 3 is a pictorial diagram illustrating the social graph 202 reduced into corresponding user sketches and combined into the Web graph 204. For example and with reference to both FIGS. 2 and 3, user sketch 306, corresponding to user 206, is associated with document 216 in the Web graph 204 indicating the inter-graph relationship 228. Also associated with document 216 is user sketch 308 corresponding to user 208. User sketches 308 and 314 are associated with document 224; user sketch 314 is associated with document 222; user sketch 312 (i.e., the user sketch corresponding to user 212) is associated with document 226; user sketch 310 is associated with document 220; and user sketch 206, in addition to being associated with document 216, is also associated with document 218.

It should be appreciated that the examples set forth through FIGS. 2 and 3 are relatively simple: combining a small number of users, documents, and inter-graph relationships. However, there are currently millions of users participating in social networks and a typical Web graph hosted by a search engine will generally reference billions of documents on the Web. Moreover, individual users could have hundreds or even thousands of “relationships” with content (such as “liking” content or sources, previously browsing a Web site, authoring a document, a product review, and the like). Thus, storing social graph information (as sketches) for each user and their inter-graph relationship data with the content of a real world Web graph, as represented in a search engine's content index, is challenging if not impractical.

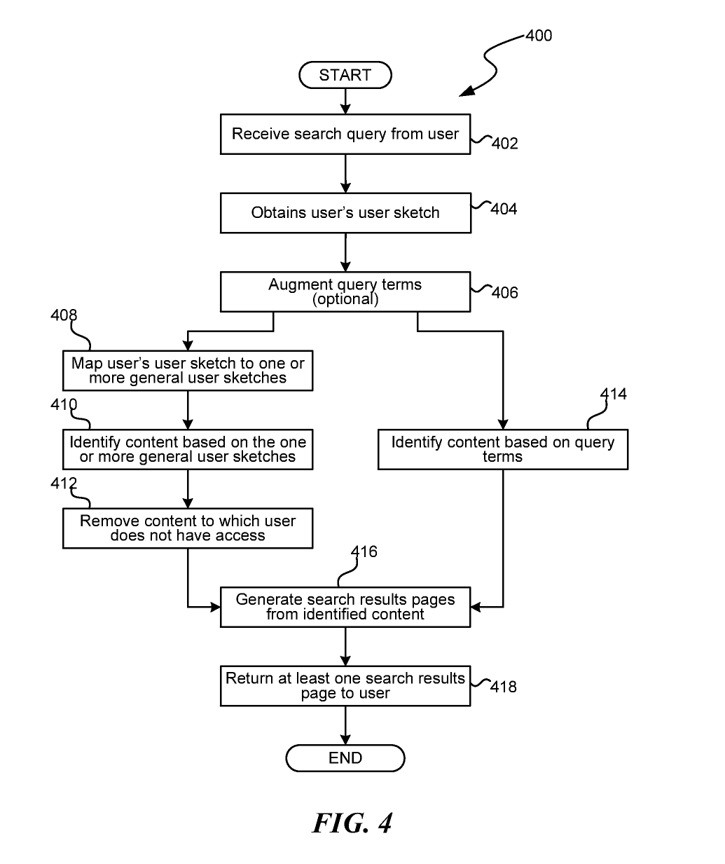

According to at least one embodiment of the disclosed subject matter, rather than incorporating the user sketches of all available users into a content index, a search engine 110 selects (or creates) general user sketches and incorporates the general user sketches into the content index. The general user sketches are representative sketches and are selected from a body of user sketches (or created in view of a body of user sketches) as being generally representative of that body of sketches. In operation, upon receiving a search query from a user, the search engine 110 maps the user to one or more general user sketches and retrieves search results based the query terms of the search results and also based on the relationships between the general user sketch and the content in the Web graph 204 (as found in the search engine's content index.) This process of retrieving search results based on query terms from the search query and on the relationships between the user sketch and the content in the Web graph 204 is discussed below in regard to FIG. 4.

Indeed, turning to FIG. 4, this figure illustrates an exemplary routine 400 for responding to a user's search query based on query terms from the search query and based, at least in part, on the relationships between the user's user sketch and the content in the Web graph 204. Beginning at block 402, a search engine 110 receives a search query from a user. As those skilled in the art will recognize, the search query will include query terms (both words and phrases) for which the user is requesting search results. Moreover, according to aspects of the disclosed subject matter, as the search engine 110 will attempt to find results, at least in part, according to relationships the user has with regard to content (i.e., the inter-graph relationships between the user's social graph 202 and the Web graph 204), the search query may optionally include a distance value. The distance value represents the distance that the search engine can traverse in the user's social graph 202 in discovering search results for the user in response to the search query. A distance of “0” would instruct the search engine 110 to explore the user's social graph no farther in locating search results via the user's social graph than direct relationships between the user and content in the Web graph 204. For example, with reference to FIG. 2, if the user submitting the search query is user 206 and the optional distance value is “0”, then the search engine would evaluate documents 216 and 218 of the Web graph 204 in responding to the search query. Of course, limiting the search engine 110 to a distance does not mean that the search engine cannot locate search results that might be discovered if the distance were increased. In response to the search query from user 206, the search engine 110 might find that document 220 is highly relevant to the query terms and return a search result referencing that document. Rather, setting the distance value in a search query limits the distance that the search engine 110 will search for content by way of the user's social graph 202.

In regard to the optional distance value, as an optional value a search engine 110 may be configured in any number of ways to respond when it is not specified. By way of non-limiting examples, a search engine 110 may be configured to not explore the user's social graph 202 if a distance value is not specified; supply a default value (e.g., a distance of “0” or “1”) if a distance value is not specified; or make use of the entire extent of the user's social graph if a distance value is not specified. Further, in place of a numeric value, a user may specify a particular path or paths. For example, user 206 may specify a “distance” by including a specific user or set of users thereby limiting the discovery of content through the user's social graph to those set of users. As yet another alternative, a user may specify a combination of distance (a numeric value) and specific users as the distance value to use in locating search results responsive to a search query. All of these combinations are contemplated as falling within the scope of the disclosed subject matter.

Returning again to FIG. 4, at block 404 the search engine 110 obtains the user sketch 306 corresponding to the user 206. Obtaining the user sketch 306 may comprise retrieving the user sketch from a user sketch data store available to the search engine 110 or generating the user from the user's social graph 202. As an optional step (not shown), if the user sketch is generated the search engine may store the sketch in the user sketch data store mentioned above as a way to improve subsequent efficiency. At block 406, the search engine 110 optionally augments the query terms in the search query. Those skilled in the art will appreciate that augmenting the query terms in a search query is a common practice designed to enhance the identification of potential search results responsive to the search query.

After block 406, the exemplary routine 400 moves to blocks 408 and 414, two paths which may be executed in concert, in parallel, or in series. At block 408, the search engine 110 maps the user's user sketch to one or more general user sketches that the search engine has used as representative sketches. At block 410, the search engine 110 identifies content responsive to the search query (i.e., via the general user sketch). As mentioned above, identifying content according to the user's social graph takes into account any distance value that may have been supplied with the user's search query.

Since a general user sketch is only representative and does not (in most cases) accurately reflect the user's particular social graph 202, there exists a likelihood that the content identified by the general user sketch is not content with which the user has a multi-graph relationship. Moreover, these also exists the likelihood, especially in regard to social graph relationships, that a general user sketch will identify content to which the user does not have access. For example, consider the example of users 206 and 210 of FIG. 2. Suppose that user 210 has created a personal document 220 and has granted permission to view the document 220 only to user 206. Other users in the social graph of user 206, such as user 212, would not have access. However, when relying upon a general user sketch to identify content, specific rules of access between users cannot be maintained. Hence, a general user sketch may identify content to which the requesting user does not have access. Accordingly, at block 412, the search engine refers to the user's user sketch to determine whether the user has access to the content identified in block 410. That content for which the user does not have access is removed as identified content.

Turning now to the other path, at block 414 the search engine 110 identifies content responsive to the search query according to the various techniques currently employed by search engines including, but not limited to, content relevance/scoring, user preferences, and the like. After the conclusion of blocks 412 and 414 (whether implemented in parallel, in series, or jointly, at block 416) and with a combined set of identified content from both paths, the search engine 110 generates one or more search results pages. At block 412, the search engine 110 returns at least the first generated search results page to the user in response to the search query. Thereafter, the routine 400 terminates.

While the exemplary routine 400 of FIG. 4 is illustrated and described as comprising two separate processing threads (i.e., steps 408-412 and step 414) whose disparate results are subsequently merged into a single set of responsive search results (step 416), this should be viewed as an illustrative embodiment, set forth to illustrate the various components of both process threads, but should not be viewed as limiting upon the disclosed subject matter. In various embodiments of the disclosed subject matter, identifying search results according to sketches may be combined with identifying content according to relevance to query terms into a single process thread. Moreover, combining both techniques into a single process thread may identify highly relevant search results that neither process thread (identifying content via sketches or identifying content via relevance to query terms) might identify. For example, the most relevant search result may be one that is somewhat relevant to the query and liked by a friend-of-a-friend, more so than content that is highly textually relevant query terms or content marginally relevant to the query but liked by one or more friends. If processed via separate process threads, such highly relevant result may be missed, but identifies when both techniques are combined into the same process thread.

As those skilled in the art will appreciate, routine or methods, such as routine 400, are described in terms of steps to carry out various functionality of the disclosed subject matter. It should be appreciated, however, that the steps identified in these routines are logical steps and may or may not correspond to actual steps carried out in an actual implementation of the disclosed subject matter. Moreover, those skilled in the art will appreciate that the individual steps, themselves, are often comprised of many discrete instructions. On a computer, these instructions are retrieved from a memory/instruction store and executed by a processor. Execution of these instructions may or may not be carried out in conjunction with other physical and/or logical components of the computer.

While various aspects of the disclosed subject matter are expressed as steps in routines or methods, the functionality of these various aspects may also be embodied in computer-readable media. As those skilled in the art will appreciate, computer-readable media can host computer-executable instructions for later retrieval and execution, including instructions for carrying out the functionality of the subject matter disclosed in this document. When executed by a processor on a computing device, the computer-executable instructions carry out various steps or methods. In this regard, computer-readable media may serve as the memory/instruction store mentioned above. Examples of computer-readable media include, but are not limited to: optical storage media such as digital video discs (DVDs) and compact discs (CDs); magnetic storage media including hard disk drives, floppy disks, magnetic tape, and the like; transitory and non-transitory memory such as random access memory (RAM), read-only memory (ROM), memory cards, thumb drives, and the like; cloud storage (i.e., an online storage service); and the like. While it is possible to execute instructions obtained via carrier waves and/or propagated signals, for purposes of this document, computer-readable media expressly excludes carrier waves and propagated signals.

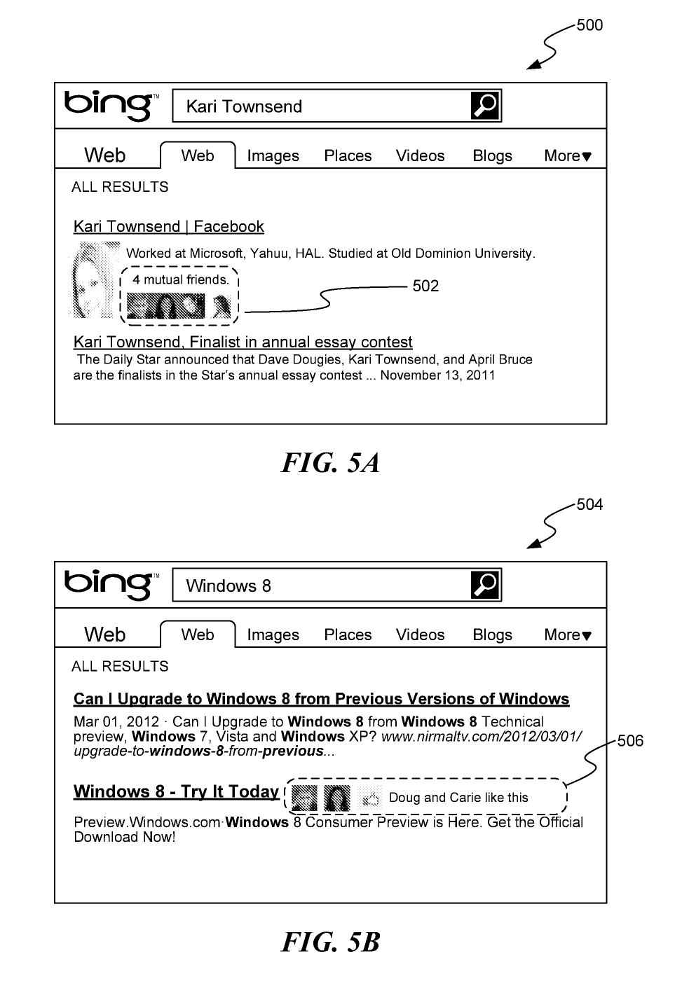

While it is common practice for search engines to generate and return one or more search results pages in response to a search query, a search engine 110 that is configured to identify content in response to a search query based, in part, on a user's social graph 202 can also display information as to why a particular search result is included in a search results page. According to at least one embodiment of the disclosed subject matter, when generating a search results page, if the content referenced by a search result was identified through the use of the user's social graph (via the user sketch), an indication as to why/how that search result is related to the user is included in the search results page. FIGS. 5A and 5B are pictorial diagrams illustrating exemplary search results with distance information indicative of graph-based searching.

FIG. 5A shows an exemplary view of a generated search results page 500 responsive to a sample search query, “Kari Townsend.” For purposes of the illustration, it is assumed that the first result was identified through the use of a user's social graph. Correspondingly, the search engine 110 generated the search results page 500 to include an indication 502 that the result was identified using the submitter's social graph. In the present example, the indication 502 suggests that the search result was identified through at least 4 different contacts/friends within the submitter's social graph.

FIG. 5B shows an exemplary view of another generated search results page 504 responsive to a sample search query, “Windows 8.” For purposes of the illustration, it is assumed that the second result on the search results page 504 was identified through the user of the submitter's social graph. Correspondingly, the search engine 110 generated the search results page 504 to include an indication 506 that the second search result was identified using the submitter's social graph. In this example, the indication 506 demonstrates that at least two of the submitter's friends “liked” the search result.

While the majority of the discussion above has been made in the context of a graph in relation to a user, it should be noted that the disclosed subject matter is not limited in this manner. According to various embodiments of the disclosed subject matter, an initial graph position (rather than originating with a user) may be associated with an attribute of a search query. For example, an automated system might issue thousands of queries (or any arbitrary number) to an underlying search system, and each of the automated queries will have some position in one or more graphs which will be used to augment the query. In this example, the query might include a starting document in a web graph, so of the query-based sketch positions would be the sketch of the document's position in the web graph. Additionally, while the majority of the discussion above has been made with regard to a single graph (such as the social graph 202) to augment a search query, this have been for purposes of clarity in description and should not be viewed as a limitation upon the disclosed subject matter. Indeed, any number of graphs may be used to augment a single search query. Accordingly, the disclosed subject matter should not be viewed as limited to the use of a single graph in augmenting a search query. Still further, in addition to augmenting search queries, the various techniques disclosed herein could also advantageously be used to affect the filtering, ranking, and/or presentation of search results by the search engine 110.

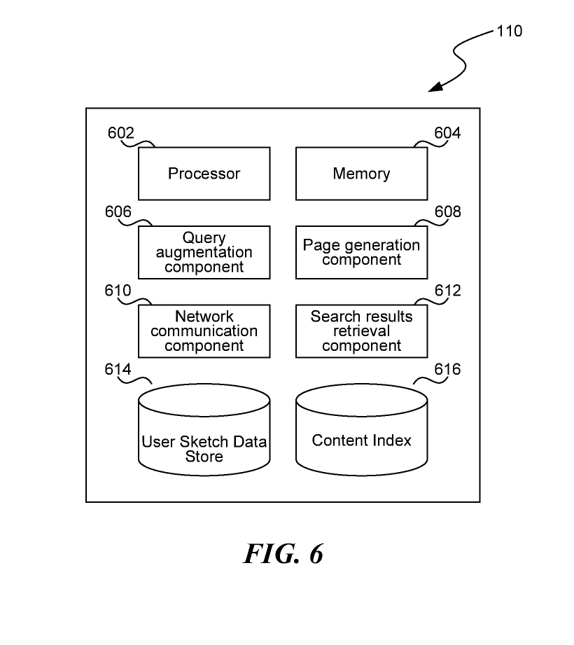

Turning now to FIG. 6, this figure illustrates exemplary components of a search engine 110 suitably configured to implement the graph-based searching techniques described throughout this document. As shown, the exemplary search engine 110 includes a processor 602 and a memory 604. As those skilled in the art will appreciate, the processor 602 executes instructions retrieved from memory 604 in carrying out various aspects of the hosted search engine service, including responding to search queries with results obtained, in part, from graph-based searching.

The search engine 110 also includes a network communications component 610 through which the search engine 110 sends and receives communications over the network 108. For example, it is through the network communication component 610 that the search engine 110 receives search queries from user computers, such as user computers 102-106, and returns results responsive to the search queries. The search engine 110 also includes additional components such as a search results retrieval component 612, a query augmentation component 606, a content index 616, a user sketch data store 614, and a page generation component 608. Regarding these additional components, it should be appreciated that these should be viewed as logical components for carrying out various functions of suitable configured search engine 110. These logical components may or may not correspond directly to actual and/or physical components. Moreover, in an actual embodiment, these components may be combined together or broke up across multiple actual components.

The query augmentation component, while an optional component, is responsible for augmenting the search query submitted by a user with related and/or expanded query terms. This augmentation is performed to enhance the scope of content that is identified as being relevant to the search query. Regarding the search results retrieval component 612, this logical component is responsible for retrieving or obtaining search results relevant to the user's search query (or the augmented query) from the content index 616. The search results retrieval component 612 is configured to obtain/retrieve search results by standard query-term searching techniques as well as by graph-based searching techniques which have been described above. In this logical arrangement, the search results retrieval component 612 is also responsible for removing those search results, identified through the graph-based searching, to which the user submitting the search query does not have access.

The content index 616 is something of a misnomer in that for many search engines this index typically stores references to content, not the content itself. However, the content index 616 is not limited to storing just references to content and may also store the actual content. As mentioned above, the content index 616 includes information regarding a Web graph 204 and further includes general user sketches (or user sketches if so implemented) and the inter-graph relationships in association with the content or references to content. The user sketch data store 614 stores a plurality of individual user sketches, and may be configured to store general user sketches and mappings (or associations) between the user sketches and the general user sketches.

While various novel aspects of the disclosed subject matter have been described, it should be appreciated that these aspects are exemplary and should not be construed as limiting. Variations and alterations to the various aspects may be made without departing from the scope of the disclosed subject matter.

1. A method, as implemented through the execution of computer executable instructions on a computing device comprising at least a processor and a memory, for responding to a search query, the method comprising:
obtaining a user sketch corresponding to a user in response to receiving a search query from the user;
mapping the user sketch to a general user sketch;
obtaining a set of search results from a content index responsive to the search query, wherein the set of search results is obtained in part as a function of a relationship distance between the content referenced by the at least one search result and the user according to the general user sketch;
generating a search results page from the set of search results, the search results page including search results obtained as a function of the relationship distance between the content referenced by the at least one search result and the user; and
providing the generated search results page to the user in response to the search query.

2. The method of claim 1, wherein the content index comprises an index of references to content and wherein a plurality of the references to content are associated with one or more general user sketches in the content index.

3. (canceled)

4. The method of claim 2 further comprising determining whether the user has access to the content referenced by the search results in the set of search results and removing the search results from the set when the user does not have access to the corresponding content.

5. The method of claim 1, wherein the search query identifies the relationship distance for obtaining the set of search results.

6. The method of claim 1 further comprising augmenting the search query with alternative query terms and obtaining the set of search results from the content index according to the search query, the augmented query terms and the user sketch.

7. The method of claim 1, wherein the user sketch is representative of the user's social graph.

8. The method of claim 1, wherein generating the search results page from the set of search results including the at least one search result comprises providing an indication that the at least one search result was obtained in part as a function of a relationship distance between the content referenced by the at least one search result and the user according to the user sketch.

9. A computer system for responding to a search query from a user, the computer system comprising a processor and a memory, and further comprising:
a content index comprising an index of references to content, and further comprising a general user sketch associated with at least one reference to content;
a user sketch component that, responsive to a search query, obtains a user sketch corresponding to the user submitting the search query;
a retrieval component that, responsive to the search query, retrieves a set of search results from the content index according to the search query and the user sketch, wherein the set of search results includes one or more search results retrieved, in part, as a function of a relationship distance between the content referenced by the one or more search results and the user according to the user sketch;
an access management component that determines whether the user has access to the one or more search results retrieved, in part, as a function of a relationship distance between the content referenced by the at least one search result and the user and removes those search results to which user does not have access; and
a search results page generator that generates one or more search results pages from the retrieved set of search results and, for search results retrieved, in part, as a function of the relationship distance, includes a corresponding indication of the relationship distance between the referenced content and the user.

10. The system of claim 9, wherein the retrieval component retrieves the one or more search results as a function of a relationship distance between the referenced content and the user by mapping the user sketch to at least one general user sketch.

11. The system of claim 10, wherein the user sketch is representative of the user's social graph.

12. The system of claim 10, wherein the search query identifies the relationship distance used by the retrieval component to retrieve the one or more search results retrieved as a function of a relationship distance.

13. The system of claim 10, wherein the indication that a search result was retrieved, in part, as a function of a relationship distance between the referenced content and the user includes the distance between the referenced content and the user.

14. The system of claim 9 further comprising a query augmentation component that augments the search query with related query terms, and wherein the retrieval component retrieves the set of search results from the content index according to the search query, the related query terms and the user sketch.

15. A computer readable medium bearing computer executable instructions which, when executed on a computer comprising at least a processor for executing the instructions, carry out a method for responding to a search query, the method comprising:
obtaining a user sketch corresponding to a user in response to receiving a search query from the user;
mapping the user sketch to a general user sketch;
obtaining a set of search results from a content index responsive to the search query, wherein the set of search results is obtained, in part, as a function of a relationship distance between the content referenced by the at least one search result and the user according to the general user sketch;
generating a search results page from the set of search results, the search results page including search results obtained as a function of the relationship distance between the content referenced by the at least one search result and the user; and
providing the generated search results page to the user in response to the search query.

16. The computer readable medium of claim 15, wherein the context index comprises an index of references to content, and wherein one or more references in the content index are associated with at least one general user sketch in the content index.

17. The computer readable medium of claim 15, wherein the search query identifies the relationship distance used in obtaining the at least one reference as a function of a relationship distance.

18. The computer readable medium of claim 15, wherein the user sketch is representative of the user's social graph.

19. The computer readable medium of claim 15, wherein generating the search results page from the set of search results providing an indication that the at least one search result was obtained, in part, as a function of a relationship distance between the content referenced by the at least one search result and the user.

20. The computer readable medium of claim 15, wherein the method further comprises augmenting the search query with alternative query terms and obtaining a set of search results from the content index according to the search query, the augmented query terms and as a function of a relationship distance according to the user sketch.
